(19) United States
(12) Patent Application Publication
(10) Pub. No.: US 2021/0107716 A1
(43) Pub. Date: Apr. 15, 2021

(54) MULTI-SECTION PACKAGE FOR INSTANT COFFEE HAVING A PLURALITY OF SEALED FLEXIBLE PACKETS COMBINED TOGETHER

(71) Applicant: Hee-Young HWANG, Fairfax, VA (US)

(72) Inventor: Hee-Young HWANG, Fairfax, VA (US)

(21) Appl. No.: 16/653,076

(22) Filed: Oct. 15, 2019

(51) Int. Cl. B65D 75/42; B65D 75/52; B65D 75/58; B65D 75/54; B65D 85/80; A23F 5/40

(52) U.S. Cl. CPC B65D 75/42; B65D 75/527; A23F 5/40; B65D 75/54; B65D 85/80; B65D 75/5827

(57) ABSTRACT

A multi-section package for instant coffee includes a plurality of sealed flexible packets connected together, each of the plurality of sealed flexible packets being configured to contain a predetermined quantity of contents. In the multi-section package, each of the plurality of sealed flexible packets has a heat-sealed wing disposed at an end thereof and a cutting line formed on a surface thereof adjacent to the heat-sealed wing.

### TECHNICAL FIELD

The present disclosure relates to an instant coffee package, and more particularly, to a multi-section package for instant coffee having a plurality of sealed flexible packets each containing different contents such as coffee, sugar or creamer.

### RELATED ART

Instant coffee, also called soluble coffee, coffee crystals, and coffee powder, is a beverage derived from brewed coffee beans that enables people to quickly prepare hot coffee by adding hot water or milk to the powder or crystals and stirring. Instant coffee is commercially prepared by either freeze-drying or spray drying, after which it can be rehydrated. Instant coffee in a concentrated liquid form is also manufactured.

Advantages of instant coffee include speed of preparation (instant coffee dissolves quickly in hot water), lower shipping weight and volume than beans or ground coffee (to prepare the same amount of beverage), and long shelf life—though instant coffee can spoil if not kept dry. Instant coffee also reduces cleanup since there are no coffee grounds.

Instant coffee may be packaged in a plurality of plastic stick packets which can be easily used for individual consumer. However, it is inconvenient for a consumer to make a mixed coffee with this coffee stick because he or she always needs to bring separate sugar stick and/or a creamer capsule together with the coffee stick. In some Asian countries such as South Korea or Japan, stick packets containing a mix of coffee, sugar, and powdered creamer are widely sold. Although these coffee mix packets are convenient to use, it cannot meet all of different preferences of various consumers, because it is difficult to select different combinations of contents or adjust an amount of each selected one. For example, consumers may prefer one of a black coffee without any other flavors; a mix of coffee and sugar; a mix of coffee, sugar, and creamer; or a mix of coffee and creamer. Also, consumers may want more or less sweetened coffee by adjusting an amount of sugar. However, if there are only one type of instant mixes, those different preferences cannot be met.

Thus, there is a need for a multi-section package for instant coffee having a plurality of packets each containing different contents such as coffee, sugar or creamer that can overcome the above-identified problems.

### SUMMARY

The present disclosure provides a multi-section package for instant coffee having a plurality of sealed flexible packets each containing different contents.

According to various embodiments of the present disclosure, the multi-section package for instant coffee may have a plurality of sealed flexible packets connected together, each of the plurality of sealed flexible packets being configured to contain a predetermined quantity of contents, wherein each of the plurality of sealed flexible packets has a heat-sealed wing disposed at an end thereof and a cutting line formed on a surface thereof adjacent to the heat-sealed wing. The contents contained in each of the plurality of sealed flexible packets may be coffee, sugar, milk, or creamer.

In accordance with the first embodiment, the plurality of sealed flexible packets, each having a rectangular-like shape, are arranged in a row, wherein all of heat-sealed wings of the plurality of sealed flexible packets are arranged at same side ends of the packets in the same direction. In this embodiment, front end portions of the plurality of packets on which the heat-sealed wings are respectively disposed are separated by gaps from each other to an extent that each gap is formed crossing cutting lines of each pair of bordering packets.

In accordance with the second embodiment, the plurality of sealed flexible packets, each having a rectangular-like shape, are arranged in a row, wherein any adjacent two of heat-sealed wings of the plurality of sealed flexible packets are arranged at opposite side ends of the respective packets in the same direction. In this embodiment, front end portions of the plurality of packets are separated by front gaps from each other to an extent that each front gap is formed extending over at least one cutting line of the plurality of packets, wherein rear end portion of the plurality of packets are separated by rear gaps from each other to an extent that each rear gap is formed extending over at least one cutting line of the plurality of packets.

In accordance with the third and fourth embodiments, the plurality of sealed flexible packets, each having a triangular-like shape, are arranged by bordering each other, wherein all of heat-sealed wings of the plurality of sealed flexible packets are arranged at different side ends of the respective packets. In these embodiments, outer end portions of the plurality of packets are separated by gaps from each other to an extent that each outer gap is formed crossing cutting lines of each pair of bordering packets.

In the third embodiment, in particular, the number of the plurality of sealed flexible packets is three (3), and the multi-section package has a triangular-like shape, while in the forth embodiment, the number of the plurality of sealed flexible packets is four (4), and the multi-section package has a square-like shape. In the fourth embodiment, one of the plurality of sealed flexible packets includes a rolled stir stick.

### BRIEF DESCRIPTION OF THE DRAWINGS

The teachings of the present invention can be more readily understood by considering the following detailed description in conjunction with the accompanying drawings.

FIG. 1A is a perspective view showing a front side of the multi-section package for instant coffee according to the first embodiment of the present disclosure; FIG. 1B is a cross-sectional illustration of the multi-section package disclosed in FIG. 1A, taken along section line A-A′; and

FIG. 1C is a cross-sectional illustration of the multi-section package disclosed in FIG. 1A, taken along section line B-B′.

FIG. 2 is a front view of the multi-section package for instant coffee according to the second embodiment of the present disclosure.

FIG. 3 is a front view of the multi-section package for instant coffee according to the third embodiment of the present disclosure.

FIG. 4 is a front view of the multi-section package for instant coffee according to the fourth embodiment of the present disclosure.

### DETAILED DESCRIPTION

Reference will now be made in detail to embodiments of the present disclosure, examples of which are illustrated in the accompanying drawings. It is noted that wherever practicable, similar or like reference numbers may be used in the drawings and may indicate similar or like elements.

The drawings depict embodiments of the present disclosure for purposes of illustration only. One skilled in the art would readily recognize from the following description that alternative embodiments exist without departing from the general principles of the present disclosure.

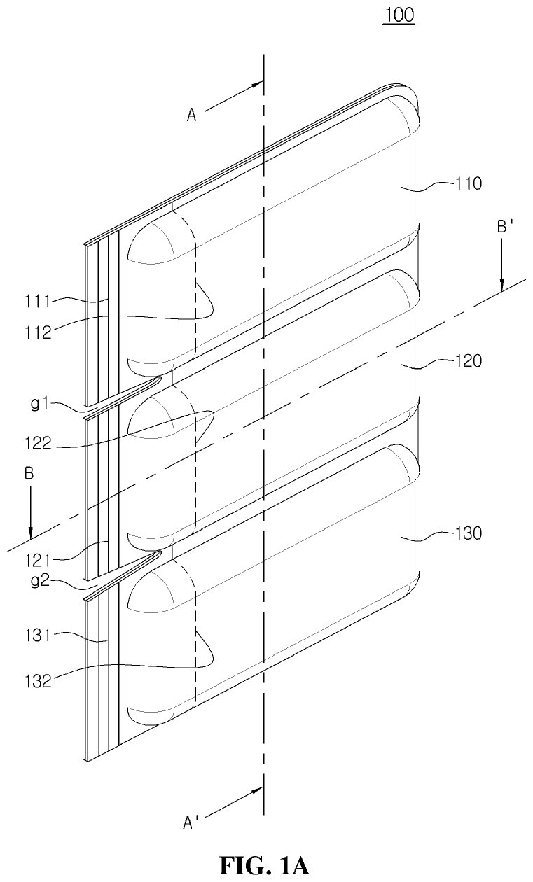

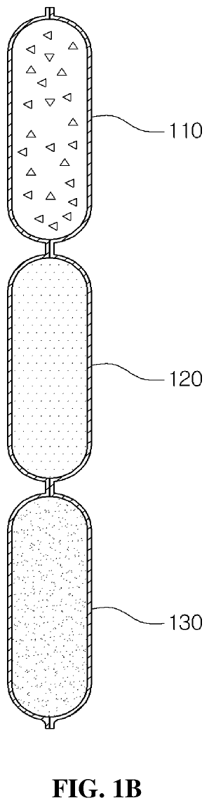

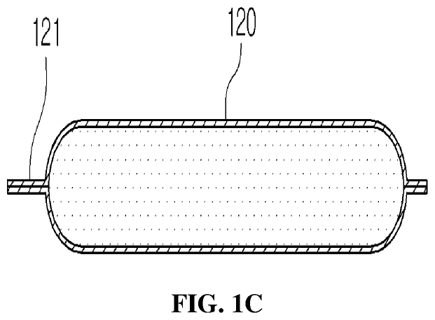

FIG. 1A is a perspective view showing a front side of the multi-section package for instant coffee according to the first embodiment of the present disclosure; FIG. 1B is a cross-sectional illustration of the multi-section package disclosed in FIG. 1A, taken along section line A-A′; and FIG. 1C is a cross-sectional illustration of the multi-section package disclosed in FIG. 1A, taken along section line B-B′.

As shown in FIG. 1A, the multi-section package 100 for instant coffee according to the first embodiment of the present disclosure may include three sealed flexible packets 110, 120, 130 connected together, each of the packets being configured to contain a predetermined quantity of contents such as coffee, sugar or creamer, which may be in particulate form.

Each packet (110, 120, or 130) may have at least one layer of a gas and moisture impermeable flexible packaging material (e.g., polyethylene) sealed about their periphery so as to provide a gas and moisture resistant container for coffee, sugar or creamer housed therein.

Each packet (110, 120, or 130) has a heat-sealed wing (111, 121, or 131) disposed at an end thereof and a cutting line (112, 122, or 132) formed on a surface thereof adjacent to the heat-sealed wing. This cutting line is to allow a consumer to easily cut the packet by a reasonable force, and may be formed by partially compressed or printed along a dot line.

In the first embodiment, the three packets 110, 120, 130, each having a rectangular-like shape as shown in FIG. 1A, are arranged in a row, and all of heat-sealed wings 111, 121, 131 of the packets are arranged in the same direction. The three packets 110, 120, 130 are coupled together by generally bordering each other, however, front end portions of the packets on which the heat-sealed wings 111, 121, 131 are respectively disposed are separated by gaps g1, g2 from each other to the extent that each gap is formed crossing cutting lines of each pair of bordering packets as shown in FIG. 1A, so that the consumer may easily grip each front end portion of each packet to open it by tearing along the cutting line. As shown in FIG. 1B, the three packets may be formed as one body and divided from each other by heat sealing.

Due to the above-mentioned features of the first embodiment in the present disclosure, the consumer can choose at least one of the three packets depending on a personal preference, and make coffee by mixing those different contents contained in the selected packets. Also, the amount of each contents will be easily adjusted depending on the personal preference because each of the different contents is contained in a separate packet and it is easy to hold unnecessary amount of contents by pushing certain point of the packet.

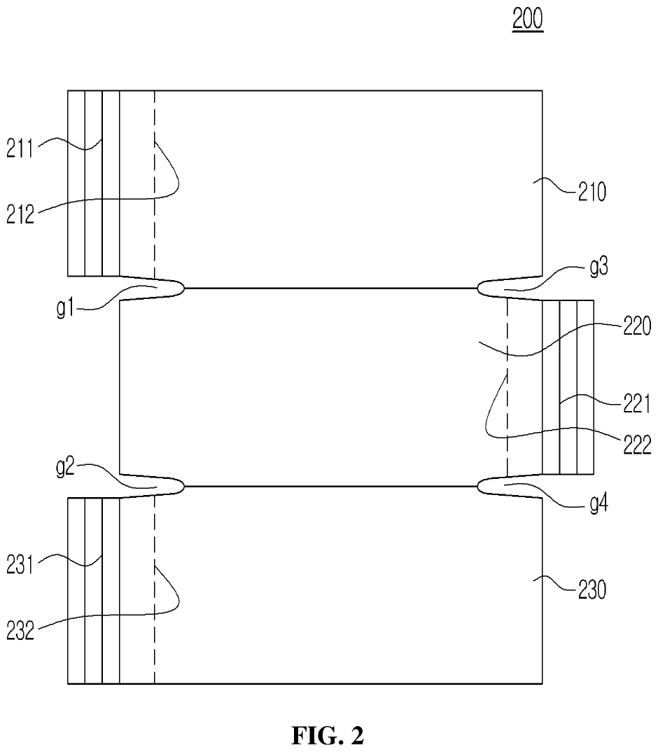

FIG. 2 is a front view of the multi-section package for instant coffee according to the second embodiment of the present disclosure.

As shown in FIG. 2, the multi-section package 200 for instant coffee according to the second embodiment of the present disclosure may also include three sealed flexible packets 210, 220, 230 connected together, each of the packets being configured to contain a predetermined quantity of contents such as coffee, sugar or creamer, which may be in particulate form.

Each packet (210, 220, or 230) may have at least one layer of a gas and moisture impermeable flexible packaging material (e.g., polyethylene) sealed about their periphery so as to provide a gas and moisture resistant container for coffee, sugar or creamer housed therein.

Each packet (210, 220, or 230) has a heat-sealed wing (211, 221, or 231) disposed at an end thereof and a cutting line (212, 222, or 232) formed on a surface thereof adjacent to the heat-sealed wing. This cutting line is to allow a consumer to easily cut the packet by a reasonable force, and may be formed by partially compressed or printed along a dot line.

In the second embodiment, the three packets 210, 220, 230, each having a rectangular-like shape as shown in FIG. 1A, are arranged in a row, and any adjacent two of heat-sealed wings of the plurality of sealed flexible packets are arranged in opposite directions. That is, in the second embodiment, a first heat-sealed wing 211 is disposed at a front end of a first packet 210, while a second heat-sealed wing 221 is disposed at a rear end of a second packet 220. Likewise, a third heat-sealed wing 231 is disposed at a front end of a third packet 230, while the second heat-sealed wing 221 is disposed at the rear end of the second packet 220.

The three packets 210, 220, 230 are coupled together by generally bordering each other, however, front end portions of the plurality of packets are separated by front gaps g1, g2 from each other to the extent that each front gap is formed extending over at least one cutting line (212 and/or 232) of the plurality of packets, wherein rear end portion of the plurality of packets are separated by rear gaps g3, g4 from each other to the extent that each rear gap is formed extending over at least one cutting line 222 of the plurality of packets as shown in FIG. 2, so that the consumer may easily grip each front or rear end portion of each packet to open it by tearing along the cutting line. The three packets may be formed as one body and divided from each other by heat sealing.

Due to the above-mentioned features, similar advantages as the first embodiment are expected by the second embodiment. Further, since a cutting line of one packet is formed on the opposite side of another cutting line of its bordering packet, it is easy for the user to grip each packet to open it along its cutting line without being interfered by any bordering packet.

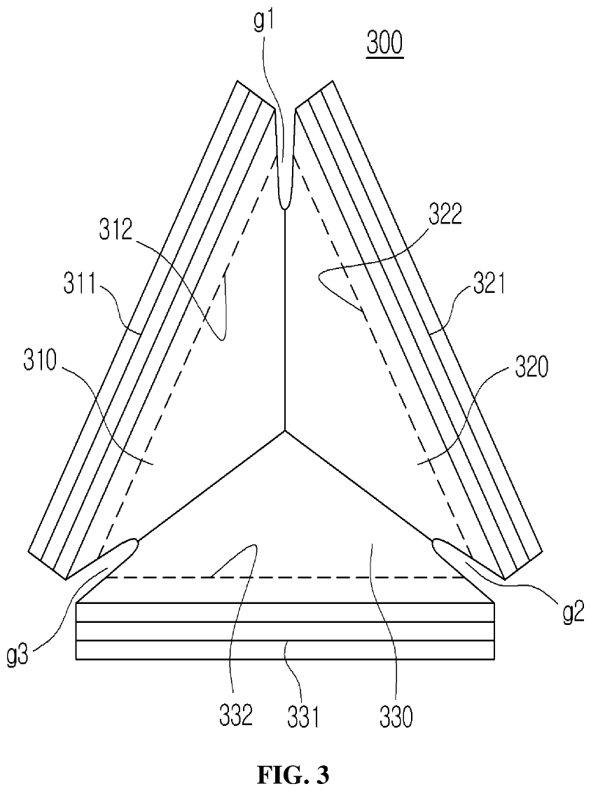

FIG. 3 is a front view of the multi-section package for instant coffee according to the third embodiment of the present disclosure.

As shown in FIG. 3, the multi-section package 300 for instant coffee according to the third embodiment of the present disclosure may have a triangular-like shape including three sealed flexible packets 310, 320, 330 connected together, each of the packets being configured to contain a predetermined quantity of contents such as coffee, sugar or creamer, which may be in particulate form.

Each packet (310, 320, or 330) may have at least one layer of a gas and moisture impermeable flexible packaging material (e.g., polyethylene) sealed about their periphery so as to provide a gas and moisture resistant container for coffee, sugar or creamer housed therein.

Each packet (310, 320, or 330) has a heat-sealed wing (311, 321, or 331) disposed at an end thereof and a cutting line (312, 322, or 332) formed on a surface thereof adjacent to the heat-sealed wing. This cutting line is to allow a consumer to easily cut the packet by a reasonable force, and may be formed by partially compressed or printed along a dot line.

In the third embodiment, the three packets 310, 320, 330, each having a triangular-like shape, are arranged by bordering each other, wherein all of heat-sealed wings 311, 321, 331 of the plurality of sealed flexible packets are arranged in different directions. That is, as shown in FIG. 3, a first center line (towards a first heat-sealed wing) of a first packet 310 and a second center line (towards a second heat-sealed wing) of a second packet 320 form an angle of 120 degree, and a second center line (towards a second heat-sealed wing) of the second packet 320 and a third center line (towards a third heat-sealed wing) of a third packet 330 form an angle of 120 degree. These angles are not limited to 120 degrees, but may be adjusted depending on the different triangular-like shapes of the package.

The three packets 310, 320, 330 are coupled together by generally bordering each other, however, outer end portions of the packets are separated by gaps g1, g2, g3 from each other to the extent that each outer gap is formed crossing cutting lines of each pair of bordering packets as shown in FIG. 3, so that the consumer may easily grip each outer end portion of each packet to open it by tearing along the cutting line. The three packets may be formed as one body and divided from each other by heat sealing.

Due to the above-mentioned features, similar advantages as the first embodiment are expected by the third embodiment. Further, since each cutting line is formed in a different direction in the third embodiment, it is also easy, like the second embodiment, for the user to grip each packet to open it along its cutting line without being interfered by any bordering packet. Moreover, unlike the second embodiment which has four gaps, the multi-section package of the third embodiment has only three gaps, thereby reducing manufacturing costs.

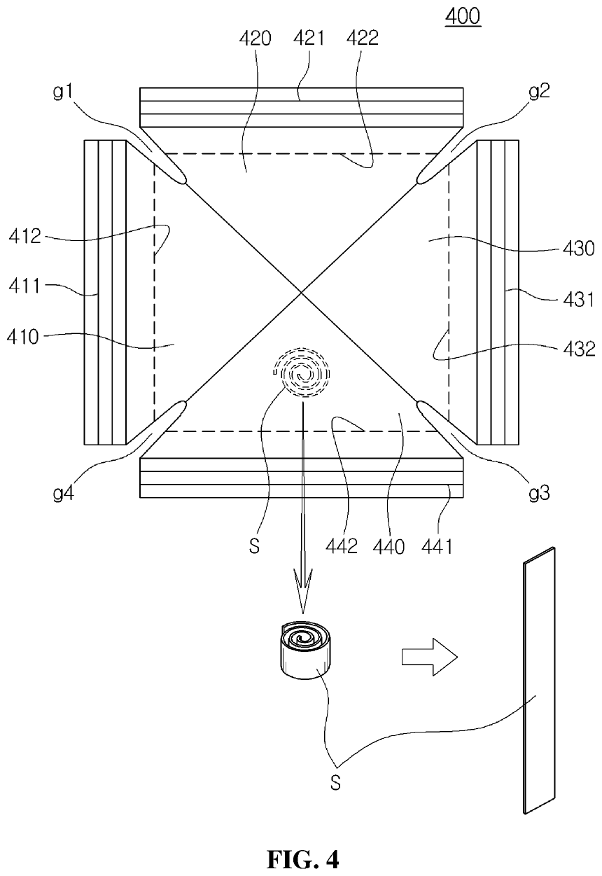

FIG. 4 is a front view of the multi-section package for instant coffee according to the fourth embodiment of the present disclosure.

As shown in FIG. 4, the multi-section package 400 for instant coffee according to the fourth embodiment of the present disclosure may have a square-like shape including four sealed flexible packets 410, 420, 430, 440 connected together, each of the packets being configured to contain a predetermined quantity of contents such as coffee, sugar or creamer, which may be in particulate form.

Each packet (410, 420, 430, or 440) may have at least one layer of a gas and moisture impermeable flexible packaging material (e.g., polyethylene) sealed about their periphery so as to provide a gas and moisture resistant container for coffee, sugar or creamer housed therein.

Each packet (410, 420, 430, or 440) has a heat-sealed wing (411, 421, 431, or 441) disposed at an end thereof and a cutting line (412, 422, 432, or 442) formed on a surface thereof adjacent to the heat-sealed wing. This cutting line is to allow a consumer to easily cut the packet by a reasonable force, and may be formed by partially compressed or printed along a dot line.

In the fourth embodiment, the four packets 410, 420, 430, 440, each having a triangular-like shape, are arranged by bordering each other, wherein all of heat-sealed wings 411, 421, 431, 441 of the plurality of sealed flexible packets are arranged in different directions. That is, as shown in FIG. 4, a first center line (towards a first heat-sealed wing) of a first packet 410 and a second center line (towards a second heat-sealed wing) of a second packet 420 form an angle of 90 degree, the second center line (towards the second heat-sealed wing) of the second packet 420 and a third center line (towards a third heat-sealed wing) of a third packet 430 form an angle of 90 degree, and the third center line (towards the third heat-sealed wing) of the third packet 430 and a fourth center line (towards a fourth heat-sealed wing) of a fourth packet 440 form an angle of 90 degree. These angles may not be limited to 90 degrees, but may be adjusted if the package 400 is configured as a rectangular-like shape instead of a square-like shape.

The four packets 410, 420, 430, 440 are coupled together by generally bordering each other, however, outer end portions of the packets are separated by gaps g1, g2, g3, g4 from each other to the extent that each outer gap is formed crossing cutting lines of each pair of bordering packets as shown in FIG. 4, so that the consumer may easily grip each outer end portion of each packet to open it by tearing along the cutting line. The four packets may be formed as one body and divided from each other by heat sealing.

Due to the above-mentioned features, similar advantages as the first embodiment are expected by the fourth embodiment. Further, since each cutting line is formed in a different direction in the fourth embodiment, it is also easy, like the second and the third embodiments, for the user to grip each packet to open it along its cutting line without being interfered by any bordering packet.

Moreover, unlike the third embodiment which has only three packets, the multi-section package of the fourth embodiment has total four packets, and thus it may contain a rolled stir stick(s) in the fourth packet, as shown in FIG. 4. This stir stick(s) may be made of any rollable material, such as a paper. Using this stir stick(s), after unrolled, the user may easily stir different contents including coffee, sugar, and creamer in a cup filled with water.

Embodiments of the present disclosure have been described in detail. Other embodiments will become apparent to those skilled in the art from consideration and practice of the present disclosure. Accordingly, it is intended that the specification and the drawings be considered as exemplary and explanatory only, with the true scope of the present disclosure being set forth in the following claims.

What is claimed is:

1. A multi-section package for instant coffee, comprising:
a plurality of sealed flexible packets connected together, each of the plurality of sealed flexible packets being configured to contain a predetermined quantity of contents,
wherein each of the plurality of sealed flexible packets has a heat-sealed wing disposed at an end thereof and a cutting line formed on a surface thereof adjacent to the heat-sealed wing.

2. The multi-section package of claim 1, wherein the contents contained in each of the plurality of sealed flexible packets is coffee, sugar, milk, or creamer.

3. The multi-section package of claim 1, wherein the plurality of sealed flexible packets, each having a rectangular-like shape, are arranged in a row, wherein all of heat-sealed wings of the plurality of sealed flexible packets are respectively arranged at same side ends of the plurality of sealed flexible packets in a same direction.

4. The multi-section package of claim 2, wherein front end portions of the plurality of packets on which the heat-sealed wings are respectively disposed are separated by gaps from each other to an extent that each gap is formed crossing cutting lines of each pair of bordering packets.

5. The multi-section package of claim 1, wherein the plurality of sealed flexible packets, each having a rectangular-like shape, are arranged in a row, wherein any adjacent two of heat-sealed wings of the plurality of sealed flexible packets are arranged in opposite side ends of the respective packets.

6. The multi-section package of claim 5, wherein front end portions of the plurality of packets are separated by front gaps from each other to an extent that each front gap is formed extending over at least one cutting line of the plurality of packets, wherein rear end portion of the plurality of packets are separated by rear gaps from each other to an extent that each rear gap is formed extending over at least one cutting line of the plurality of packets.

7. The multi-section package of claim 1, wherein the plurality of sealed flexible packets, each having a triangular-like shape, are arranged by bordering each other, wherein all of heat-sealed wings of the plurality of sealed flexible packets are arranged at different side ends of the respective packets.

8. The multi-section package of claim 7, wherein outer end portions of the plurality of packets are separated by gaps from each other to an extent that each outer gap is formed crossing cutting lines of each pair of bordering packets.

9. The multi-section package of claim 7, wherein the number of the plurality of sealed flexible packets is three, and the multi-section package has a triangular-like shape.

10. The multi-section package of claim 7, wherein the number of the plurality of sealed flexible packets is four, and the multi-section package has a square-like or a rectangular-like shape.

11. The multi-section package of claim 10, wherein one of the plurality of sealed flexible packets includes a rolled stir stick.
